(19) United States
(12) Patent Application Publication
(10) Pub. No.: US 2005/0069623 A1
(43) Pub. Date: Mar. 31, 2005

(54) Process for sanitizing animal carcasses

(76) Inventors: David J. Schneider, Union, KY (US); Charles A. Schneider, Villa Hills, KY (US)

Correspondence Address: DONALD R. BAHR, 2608 MERIDA LN, TAMPA, FL, 33618, US

(21) Appl. No.: 10/944,929

(22) Filed: Sep. 20, 2004

Related U.S. Application Data
(60) Provisional application No. 60/506,710, filed on Sep. 26, 2003.

(51) Int. Cl. A23B 4/00

(52) U.S. Cl. 426/642

(57) ABSTRACT

Animal carcasses which are destined for butchering are more often than not contaminated with bacteria. This invention is concerned with a process for sanitizing carcasses prior to butchering. To sanitize the carcass thickened solutions of a biocide are sprayed on to the carcass The preferred solutions for sanitizing the carcass in accordance with this invention have biocide concentrations of about 200 ppm. Treating solutions for use in this invention may further incorporate a coloring agent, wetting agent, surfactants, healing agents, dyes, etc. Time of contact on hide is important. The process of this invention is fast acting and is effective against a wide spectrum of bacteria. After treatment, in accordance with this invention the carcass of the animal has a substantially reduced bacteria count and hence bacterial contamination of the meat produced by the carcass is minimized. The preferred biocide is trichloromelamine (TCM). Polyethylene oxide may be used as a thickening agent.

### RELATED APPLICATIONS

This application claims priority of application Ser. No. 60/506,710, filed Sep. 26, 2003.

### FIELD OF THE INVENTION

This invention relates to animal husbandry and in particular to the raising of animals as a source of meat for human consumption.

Human beings with their frontal vision are essentially predators which are disposed to hunting other animals as a source of food. While the diet of humans is extremely diverse the best source of energy for human activities is meat. Meat is protein and protein when consumed as food is rapidly assimilated by the human digestive track and converted into energy.

Because meat is an excellent source of energy it has always been coveted as a food source.

This invention relates to the production of sanitary meat which is essentially free of bacterial contamination.

### BRIEF DESCRIPTIONS OF THE INVENTION

One of the benchmarks in human development was the domestication of animals i.e. sheep, goats, swine, cattle etc. Humans decided to domesticate wild animals in order that these animals might provide a convenient source of food. The domestication of animals often entails the keeping of the animals in confined spaces such as pig pens and feed lots. Because the domesticated animals are kept in confine spaces the outer hides of these animals are often exposed to urine and fecal matter with a net result that the hides are contaminated with bacteria. While this is not a good situation the animals are able to survive. The problem occurs when the animals are slaughtered and butchered for meat.

In the slaughtering process the animal is typically killed and hung up side down by it's rear legs. The carcass is then gutted and skinned by removing the hide from the carcass.

In the removal of the hide it is impossible to prevent the contamination of the carcass from which the hide is being removed. This hide removal process is often referred to as skinning. In the skinning process the outer side of the hide often inadvertently touches the portions of the carcass where the hide has been removed, thereby contaminating the carcass with bacteria.

This invention is concerned with a process for sanitizing the hide of an animal prior to the skinning process. In the sanitizing process the bacteria on the fur and hide of the animal are treated with a biocide in such a manner that the bacteria are killed.

More particularly this invention is concerned with a process for sanitizing an animal carcass while the animal is alive or just after it has been killed but prior to the skinning process.

Trichloromelamine is the preferred biocide for use in this invention.

In accordance with this invention the live or dead animals are treated with a solution of biocide and in particular trichloromelamine in such a manner that bacterial count on the outer surface of the animal is substantially decreased or brought to zero.

Solutions used in accordance with this invention may further incorporate wetting agents, surfactants and thickening agents in order to aid in the wetting out and retention of the biocidal solution on the animal hide.

### SUMMARY OF THE INVENTION

The subject invention as defined by the appended claims relates to a process for sanitizing animal carcasses prior to butchering.

This invention relates to the application of solutions of formulated biocides and in particular trichloromelamine, to an animal carcass prior to the butchering process.

Domesticated animals are almost always kept in confined areas for at least part of the time. These confined areas are referred to by various terms i.e. paddock, pig pens, barn yard, feed lot etc. As a result of this confinement, the confined animals are contaminated with urine and fecal matter. This contamination further causes the contamination of the carcasses with bacteria i.e. E Coli.

In accordance with this invention animal carcasses are treated with a sanitizing agent which comprises a solution of trichloromelamine. Trichloromelamaine is a known and effective biocide. Further solutions of trichloromelamine are effective against a wide range of bacteria.

### DESCRIPTION OF THE PREFERRED EMBODIMENT

In the slaughtering process an animal is typically killed and hung up side down by it's rear legs. The carcass is then gutted and skinned by removing the hide from the carcass.

As is discussed above the hide is often contaminated with bacteria such as E-coli. In the removal of the hide it is impossible to prevent the contamination of the carcass from which the hide is being removed. This hide removal process is often referred to as skinning. In the skinning process the outer side of the hide (the fur side) often inadvertently touches portions of the carcass where the hide has been removed. Further in the skinning process single or clumps of animal hairs are often dislodged from the hide. In that a single hair can harbor thousands of bacteria, if animal hair comes into contact with the portions of the carcass from which the skin has been removed the skinned carcass is contaminated with bacteria. For sanitary reasons it is highly desirable to prevent this contamination.

This invention is concerned with a process for sanitizing the hide of an animal prior to the skinning process. In the sanitizing process the bacteria on the fur and hide of the animal are treated with a biocide in such a manner that the bacteria are killed.

While it is still possible to contaminate the skinned carcass with the dead bacteria, this is usually not troublesome as the dead bacteria are not capable of multiplying to bring the bacteria count, on the skinned carcass, to an unacceptable or dangerous level.

More particularly one embodiment of this invention is concerned with a process for sanitizing an animal carcass while the animal is alive or just after it has been killed but prior to the skinning process.

Trichloromelamine (hereinafter TCM) is a known biocide which is approved for use, by the FDA, in human food preparation environments. As a biocide TCM is effective, as in solution it produces the Cl+ ion which is an outstanding biocide.

Further the use of TCM to sanitize animal carcasses is known.

In CRIS title, New Technologies to Improve and Assess Safety in Muscle Foods CRIS 1265 41420-002 an assessment of pig carcasses which were sprayed with various concentrations of TCM is made. It was found that spraying of carcasses with TCM at concentrations of 400 ppm, free available chlorine, was found to reduce aerobic bacteria on hot and chilled carcasses. Concentrations of lower than 400 ppm were not found to be effective.

In accordance with this invention the live or dead animals are treated with a solution of TCM in such a manner that bacterial count on the outer surface of the animal is substantially decreased or brought to zero.

With this decrease or elimination of the bacterial count, contamination of the skinned carcass is no longer possible.

In accordance with this invention the outer surface of the live or dead carcass is treated with a thickened solution of TCM at an effective concentration sufficient to kill the target bacteria i.e. E coli. The treating solution is thickened in order that it is retained on the carcass, for a sufficient period of time to allow the TCM time to kill the troublesome bacteria.

The preferred concentration for the biocide for use in this invention is from about 25 to about 1000 ppm. A more preferred concentration is from about 100 to about 500 ppm, a most preferred concentration range is from about 150 to about 250 ppm. A most preferred concentration is 200 ppm. One skilled in the art understands that the concentrations of the biocide depends on the particular biocide utilized and other variables i.e. temperatures.

When arriving at an effective concentration of TCM for lowering the bacteria count the bioload of the carcass must be considered. The bioload of the carcass will use up a portion of the active Cl+ ion. After this portion of the Cl+ ion is used up sufficient active Cl+ ion must remain to kill any remaining bacteria as may be present on the carcass.

All specified concentrations for the biocide are based on active chlorine.

Solutions of TCM usually kill the bacteria in 60 seconds, or less.

The treatment can be effected on live, dead or stunned animals by spraying with a solution of thickened TCM or dipped in a vat containing a solution of thickened TCM at the defined concentrations.

Solutions used in accordance with this invention may further incorporate wetting agents or surfactants in order to aid in the wetting out of the animal hide with the solution of TCM.

The preferred wetting agent for use in this invention is sodium lauryl sulfate, other wetting agents suitable for use in this invention included anionic and non ionic surfactants which are compatible with the biocide.

The concentration of the wetting agent in sanitizing compositions for use in this invention can be from about 25 to about 1000 ppm, a more preferred range is from about 100 to about 500 ppm, a most preferred concentration about 200 ppm. One skilled in the art understands that the exact concentration of the wetting agent is dependent on the particular wetting agent utilized.

It has been found that when a carcass is sprayed with a water based solutions of TCM, these solutions run off of the carcass before the sanitizing of the carcass is complete. In accordance with this invention the solution of TCM is thickened with a thickening agent in order to increase its viscosity. This increase in viscosity causes the solution of TCM to stick on and be retained on the carcass in order to give the solution of TCM time to kill the troublesome bacteria.

Suitable thickening agents for purpose of this inventions are polymeric compositions such as polyethylene oxide and a thickening agent as is sold under the trademark Poly Quatermium 10 as sold by Dow Chemical Company. It is understood by one skilled in the art that any suitable thickening agent can be used.

Other thickening agents which may be used in accordance with this invention are xanthan gum, hydroxy ethyl cellulose, hydroxy propyl cellulose and hydroxy ethyl propyl cellulose.

It is preferred that the solution of TCM be thickened to a viscosity such that it will adhere to a carcass while keeping the viscosity low enough to allow the solution to be sprayed onto the carcass. The controlling factor is not the concentration of the thickening agent, but the viscosity of the sanitizing solution. It has been found that the viscosity of the thickening agent can be from about 2 to about 10,000 centipoises. A more preferred range for the viscosity is from about 5 to about 1000 centipoises, with a most preferred range being from about 20 to about 500 centipoises, with the preferred viscosity being 125 centipoises, all specified viscosities are at 25° C.

Further coloring agents may be added in order that a visual appraisal might be made as the degree which the coverage of the animal hide with the solution of TCM has been effected.

In addition the process of this invention produces superior tanned hides and hence superior leather, as the green hide can not be adversely affected by the bacteria on the hide prior to the tanning process. This property is important as green hides are often stored for extended periods of time awaiting tanning.

The process of this invention may be effected on skinned and un-skinned carcasses. In most instances the process is effected on carcasses prior to the skinning process as the treatment of carcasses after the hide is removed is regulated by governmental authorities.

Other specific biocides which can be used in accordance with this invention are thickened solutions of polychloro isocyanurates, trichloroisocyanuric acid, dichloroisocyanuric acid, sodium or potassium dichloroisocyanurate, (mono trichloro) tetra-(monopotassium dichloro) pentaisocyanurate, dichlorodimethyl hydantoin, succinchlorimide, chloramines-T, chloromelamine and chlorinated trisodium phosphate.

While TCM is the most preferred biocide for use in this invention other preferred biocides for use in this invention are other organic Halogenated Nitrogen Deratives i.e. Chloramine T.

The following examples will illustrate the preparation of sanitizing cows by means of the subject invention. These examples are given for purposes of illustration and not for purposes of limiting this invention.

### EXAMPLES

The present invention is illustrated by the following examples. These examples are not to be construed as limiting the invention.

In the below set forth examples, a herd of twenty cows were tested for the presence or absence of Escherichia coli 0157:H7 and Salmonella. Bacterial culture test were run twice a week over a nine week period, each test involved isolating numerous, carefully controlled midline hide swabs. Three different swab tests are included in the midline hide swabs. The first were taken from the midline hide area where plain deionized water was sprayed onto the hide area in question two minutes prior to swab testing, these tests with water were blanks. The second were taken from the adjacent midline hide area where a solution of 200 ppm of trichloromelamine TCM was sprayed onto the adjacent midline hide area in question two minutes prior to testing, and the third were taken from the adjacent midline hide area where a formulated trichloromelamine solution TCM-T was sprayed onto the adjacent midline hide area two minutes prior to testing. The formula for the TCM-T solution was:

| | |
|---|---|
| Trichloromelamine TCM | 200 ppm |
| Ucarfloc 304 * | 750 ppm |
| Poly OX WSR 301 * | 250 ppm |
| Monosodium Phosphate | 400 ppm |
| Citric Acid | 390 ppm |
| Wetting Agent Calsoft F-90 (Pilot) | 150 ppm |

* Manufactured by Dow Chemical Co. Midland, Michigan

The isolated swab tests were performed using approved testing procedures. The Escherichia coli tests were done using Typtic Soy Agar, incubated 24 hours @37° C., after which counts performed using the Spiral Biotech Qcount (version 2.0, Spiral Biotech, Norwood, Mass.). The Salmonella tests were done using Tryptic Soy Agar plates, incubated @37° C. for 36 hours, after which counts performed using Qcount system (Spiral Biotech, Norton Mass.).

### Example 1

In this Example twenty cows were sprayed with water and swab cultures taken and tested for E Coli 0157:H7. The water spray had no biocidal properties. The bioanalysis of this Example provided a base line, blank data for the biocidal test as set forth below. E.coli 0157:H7 showed prevalence of 8.5%.

### Example 2

The test of Example 1 was repeated except that the test was conducted for Salmonella spp., again blank data was established. Salmonella showed a prevalence of 74.55%.

### Example 3

Using the test protocol of Example 1 twenty cows were sprayed with a solution of trichloromelamine at a concentration of 200 ppm. Test were then conducted for E.coli 0157:H7. After treatment when compared to Example 1E.coli 0157:H7, showed a prevalence of 3.5%, with a 41% count reduction

### Example 4

Using the test protocol of Example 2 twenty cows were sprayed with a solution of trichloromelamine at a concentration of 200 ppm. Test were then conducted for Salmonella spp. After treatment when compared to the test of Example 2, Salmonella showed a prevalence of 61.87% with a 17% count reduction

### Example 5

Using the test protocol of Example 1 twenty cows were sprayed with a thickened solution of TCM-T at a concentration of 200 ppm. Test were then conducted for E cole 0 1 57:H7. After treatment when compared to Example 1, E. coli showed a prevalence of 0.8% with a 94% count reduction.

### Example 6

Using the test protocol of Example 2 twenty cows were sprayed with a solution TCM-T at a concentration of 200 ppm. Test were then conducted for Salmonella spp. After treatment when compared to the test of Example 2, Salmonella spp. Showed a prevalence of 48.46% with a 35% count reduction.

### DISCUSSION OF THE EXAMPLES

As can be seen by comparing the data of Example 3 to Example 1 there was a significant reduction in the bacteria count of E coli 01 57:H7 after treatment of the cows with trichloromelamine at 200 ppm. Further comparing the data of Example 3 with Example 5 it can be seen that there was a further significant reduction in the bacteria count when the cows were sprayed with a solution TCM-T.

Likewise, comparing the data of Example 4 with the data of Example 6 it can be seen that the thickened composition of TCM-T was more effective in reducing the bacteria count of Salmonella spp.

The data of Example 5 and 6 demonstrate that thickened composition of TCM-T is more effective in killing bacteria when compared with un-thickened compositions of Examples 3 and 4.

1. A process for sanitizing an animal carcass which comprises bringing said animal carcass into contact with a thickened solution which contains an effective amount of a biocide.

2. The process of claim 1 wherein the biocide is an organic halogenated nitrogen derivative.

3. The process of claim 1 wherein the biocide is present at a concentration of from about 25 to about 1000 ppm.

4. The process of claim 2 wherein the biocide is present at a concentration of from about 100 to about 500 ppm.

5. The process of claim 1 wherein the concentration of the biocide is 200 ppm.

6. The process of claim 2 wherein the concentration of the biocide is 200 ppm.

7. The process of claim 1 whereby the solution has a viscosity of from about 2 to about 10,000 centipoises.

8. The process of claim 2 whereby the solution has a viscosity of from about 2 to about 10,000 centipoises.

9. The process of claim 3 whereby the solution has a viscosity of from about 5 to About 1,000 centipoises.

10. The process of claim 4 whereby the solution has a viscosity of from about 5 to about 1,000 centipoises.

11. The process of claim 1 wherein the solution is an aqueous solution, the biocide is trichloromelamine and this viscosity of the solution is from about 2 to about 10,000 centipoises.

12. The process of claim 2 wherein the solution is an aqueous solution, the biocide is trichloromelamine and this viscosity of the solution is from about 5 to about 1,000 centipoises.

13. The process of claim 3 wherein the solution is an aqueous solution, the biocide is trichloromelamine and this viscosity of the solution is from about 5 to about 1,000 centipoises.

14. The process of claim 4 wherein the solution is an aqueous solution, the biocide is trichloromelamine and this viscosity of the solution is from about 5 to about 1,000 centipoises.

15. The process of claim 5 wherein the solution is an aqueous solution, the biocide is trichloromelamine and this viscosity of the solution is from about 5 to about 1,000 centipoises.

16. The process of claim 6 wherein the solution is an aqueous solution, the biocide is trichloromelamine at a concentration of 200 ppm. and this viscosity of the solution is from about 5 to about 1,000 centipoises.

17. The process of claim 7 wherein the solution is an aqueous solution, the biocide is trichloramelamine at a concentration of 200 ppm and this viscosity of the solution is from about 5 to about 1,000 centipoises.

18. The process of claim 8 wherein the solution is an aqueous solution, the biocide is trichloromelamine at a concentration of 200 ppm. and this viscosity of the solution is from about 5 to about 1,000 centipoises.

19. A process for sanitizing an animal carcass which comprises bringing said animal carcass into contact with an aqueous solution of trichloromelamine, and the solution is thickened with polyethylene oxide and has a viscosity of from about 5 to about 1,000 centipoises.

20. The process of claim 19 wherein the viscosity is about 125 centipoises.
